(19) United States
(12) Patent Application Publication
(10) Pub. No.: US 2020/0030892 A1
(43) Pub. Date: Jan. 30, 2020

(54) METHOD, SYSTEM, COMPUTER PROGRAM AND A COMPUTER PROGRAM PRODUCT FOR WORKING OF A WORKPIECE

(71) Applicant: Novator AB, Spånga (SE)

(72) Inventor: Hans-Petter Andersson, Saltsjöbaden (SE)

(21) Appl. No.: 16/336,921

(22) PCT Filed: Sep. 8, 2017
(86) PCT No.: PCT/SE2017/050888

§ 371 Date: Mar. 27, 2019

(30) Foreign Application Priority Data
Oct. 25, 2016 (SE) 1651394-7

(51) Int. Cl. B23B 49/02; B23Q 15/22; G01B 21/14; G01B 21/18

(52) U.S. Cl. CPC B23B 49/02; G01B 21/18; G01B 21/14; B23Q 15/22

(57) ABSTRACT

The present disclosure relates to a method for working of a workpiece using a work tool, said workpiece having attached thereto a template with preformed guide openings located in a pattern corresponding to the positions of the holes to be formed in the workpiece. The method comprises the steps of: a) providing at least one position element at the template; b) determining the position of each guide opening in the template in relation to the at least one position element and storing the positions in a hole database in a memory containing relevant process and dimensional parameters of each hole to be formed in the workpiece; c) providing the work tool at one guide opening; d) determining the position of the work tool by means of the at least one position element; e) identifying at which guide opening the work tool has been positioned by collecting information from the hole database; f) instructing, by a control unit communicating with the hole database, the work tool to perform a working process relevant to the identified position of the work tool; and g) successively repeating the above-mentioned steps a)-f) to complete the working process for all holes in the workpiece.

### TECHNICAL FIELD

The invention relates to a method and a system for working of a workpiece, and also to a computer program and a computer program product for performing the method steps according to the appended claims.

### BACKGROUND ART

A reliable and repeatable hole quality is essential, especially in drilling applications using templates. The hole quality depends on positioning of the hole making apparatus, type of hole making apparatus, cutting tool properties, process parameters, tool wear and type of material in which the hole is produced. Hole property and quality can be measured with different types of measurement equipment and measurement methods.

When holes are produced in a workpiece it is important to identify the orientation and location of the tool in relation to the workpiece. When a template is arranged on the workpiece the orientation of the tool in relation to the workpiece is given. The template may be provided with a number of guide openings located in a pattern, so that holes corresponding to the pattern of guide openings in the template can be made. However, each guide opening must be identified, so that information can be collected about the type of hole to be produced. Also after the hole has been produced, measuring data for each individual hole is collected.

When a number of holes of a predetermined accuracy are to be made, different methods and systems are known for identifying each individual hole, collecting and registration information about the workpiece and the tool when the holes are produced in the workpiece, and also for measuring the holes after they have been produced in the workpiece.

The document EP1753570 B1 discloses a method of producing holes of various dimensions and configurations in a workpiece. A unique, individual marking or information carrier containing an identification of the hole to be formed is affixed adjacent to each guide opening on the template. The markings or information carriers may consist of any suitable type of readable ID, such as a RFID tag or chip, a pin code, a bar code, a color marking, and can be identified by a reader or sensor of a drilling machine.

Measuring devices and methods for measuring the position of a tool in relation to a workpiece are known. Document U.S. Pat. No. 5,181,809A discloses a device and a system enabling a tool to be brought to a precise location of a drilling template. However, the device is not arranged to measure the distance between the workpiece and the drilling template and therefore this device is not suitable when producing holes provided with for example a countersink.

Different types of hole making apparatuses are available. For special applications such as hole making in the aircraft structure of an aircraft the demands of accuracy are extremely high and therefore special hole making apparatuses should preferably be provided. Such a special hole making apparatus may use the orbital drilling technique. Orbital drilling is based on machining the material both axially and radially by rotating the cutting tool about its own axis as well as eccentrically about a principal axis while feeding the cutting tool through the material. The general principles in orbital drilling are for instance disclosed in U.S. Pat. No. 5,641,252A and EP1102653B1. Other types of hole making apparatuses for making holes of extremely high accuracy are also possible to use.

### SUMMARY OF THE INVENTION

Notwithstanding the existence of such prior art devices and methods described above, there is a need to effectively determinate the position of a work tool and the position where working should take place on a workpiece by said work tool. Also, there is a need to facilitate for an operator at which position on a workpiece the working of the workpiece should take place. A further need is to increase the production rate and the accuracy when working of a workpiece.

An objective problem to be solved by the invention is therefore to effectively determinate the position of a work tool and the position where working should take place on a workpiece by said work tool.

Another problem to be solved by the invention is to facilitate for an operator at which position on a workpiece the working of the workpiece should take place.

Another problem to be solved by the invention is to increase the production rate and the accuracy when working of a workpiece.

These objects above are achieved by a method for working of a workpiece according to the appended claims.

The invention relates to a method of working of a workpiece using a work tool, said workpiece having attached thereto a template with preformed guide openings located in a pattern corresponding to the positions of the holes to be formed in the workpiece. The method comprises the steps of:

a) providing at least one position element at the template;
b) determining the position of each guide opening in the template in relation to the at least one position element and storing the positions in a hole database in a memory containing relevant process and dimensional parameters of each hole to be formed in the workpiece;
c) providing the work tool at one guide opening;
d) determining the position of the work tool by means of the at least one position element;
e) identifying at which guide opening the work tool has been positioned by collecting information from the hole database;
f) instructing, by means of a control unit communicating with the hole database, the work tool to perform a working process relevant to the identified position of the work tool; and
g) successively repeating the above-mentioned steps a)-f) to complete the working process for all holes in the workpiece.

By using the at least one positioning element the position of the work tool and the position where working should take place on the workpiece by said work tool will effectively be determinated. Often a number of holes should be worked in the workpiece. By determining the position of the work tool by means of the at least one position element in relation to the guide openings in the template, the method according to the invention will facilitate for an operator at which position on the workpiece the working of the workpiece should take place. Since the method according to the invention will facilitate the working of the workpiece for the operator the production rate and the accuracy when working of a workpiece will increase.

According to an aspect of the invention, the at least one position element in step d) determining the position of the work tool by means of laser, camera, ultra sound and/or radio triangulation technique.

The position of the work tool will be accurately determined by means of a laser, camera, ultra sound and/or radio triangulation technique. These techniques may be combined for determining the position of the work tool or may be used individually. When the work tool is provided adjacent to or in one of the guide opening the at least one position element detects the position of the work tool by means of the laser, camera, ultra sound and/or radio triangulation technique. As a result, it will be possible to identifying at which guide opening the work tool has been positioned at by collecting information from the hole database in the memory. The position of each guide opening in the template in relation to the at least one positioning element may be determined at an earlier stage by using traditional measurement tools, such as a measurement scale or another gauging system.

According to an aspect of the invention, the at least one position element in step d) determining the position of the work tool by means of augmented reality technique.

When the working of the workpiece is augmented or supplemented by computer-generated sensory input the position of the work tool and the position where working should take place on the workpiece by said work tool will effectively be determined. By adding computer vision and object recognition the information about the template, work piece and work tool in front of the operator becomes interactive and digitally manipulable. The information about the template, work piece, work tool and other equipment in the environment surrounding the operator is overlaid these objects and becomes visible for the operator. Thus, the augmented reality technique according to the invention will facilitate for an operator at which position on the workpiece the working of the workpiece should take place. Since the method according to the invention will facilitate the working of the workpiece for the operator the production rate and the accuracy when working of a workpiece will increase.

According to an aspect of the invention, in which the work tool is a drilling machine comprising a rotary cutting tool, the working process in step f) comprises a hole-cutting process performed in the workpiece.

The method according to the invention will facilitate for an operator at which position on the workpiece the hole-cutting process should be performed in the workpiece. By using the at least one positioning element for positioning the drilling machine a number of holes can be worked in the workpiece with increased production rate and increased the accuracy.

According to an aspect of the invention, during the hole-cutting process in step f), the rotary cutting tool is vibrated in the longitudinal direction by means of a vibrating means or orbited in a helical motion when feeded into the workpiece.

The vibration of the rotary cutting tool leads to that the holes can be produced with high accuracy and with correct hole shape within narrow tolerances at high production rate. Also a cooling effect of both the cutting tool and the work piece is achieved when vibrating of the rotary cutting tool. The vibration also cuts the chips into smaller pieces making them easier to evacuate using a vacuum system. Instead of vibrating the rotary cutting tool, it may be orbited in a helical motion when feeded into the workpiece.

According to an aspect of the invention, in which the work tool is a measuring tool, the working process in step f) comprises a measuring process performed on the workpiece.

The objects above are also achieved by a system for working of a workpiece according to the appended claims.

The system for working of a workpiece comprises a work tool, a template attached to said workpiece, which template is provided with guide openings located in a pattern corresponding to the positions of holes to be formed in the workpiece. At least one position element is provided at the template, which the at least one position element is arranged to determine the position of the work tool and the position of the guide openings, so as to identify at which guide opening the work tool is positioned.

By providing the at least one positioning element at the template the position of the work tool and the position where working should take place on the workpiece by said work tool will be effectively determined. Often a number of holes should be worked in the workpiece. By determining the position of the work tool by means of the at least one position element in relation to the guide openings in the template, the method according to the invention will facilitate for an operator at which position on the workpiece the working of the workpiece should take place. Since the method according to the invention will facilitate the working of the workpiece for the operator the production rate and the accuracy when working of a workpiece will increase.

According to an aspect of the invention the at least one position element is attached to the template.

The at least one position element may be integrated with the template. The position of each guide opening in the template in relation to the at least one position element is fixed. The distance between each guide opening and the at least one position element may be determined by using traditional measurement tools.

According to an aspect of the invention the at least one position element is arranged at a distance to the template.

The system may be flexible and adaptable to large templates when arranging the at least one position element at a distance to the template.

According to an aspect of the invention at least one position element is attached to the work tool.

When attaching the at least one position element to the work tool a very compact and flexible system is achieved.

According to an aspect of the invention the at least one position element is based on laser, camera, ultra sound and/or radio triangulation techniques.

The position of the work tool will be accurately determined by means of a laser, camera, ultra sound and/or radio triangulation technique. These techniques may be combined for determining the position of the work tool or may be used individually. When the work tool is provided adjacent to or in one of the guide opening the at least one position element detects the position of the work tool by means of the laser, camera, ultra sound and/or radio triangulation technique. As a result, it will be possible to identify at which guide opening the work tool has been positioned at.

According to an aspect of the invention the at least one position element is based on augmented reality technique.

When the working of the workpiece is augmented or supplemented by computer-generated sensory input the position of the work tool and the position where working should take place on the workpiece by said work tool will effectively be determined. By adding computer vision and object recognition the information about the template, work piece and work tool in front of the operator becomes interactive and digitally manipulable. The information about the template, work piece, work tool and other equipment in the environment surrounding the operator is overlaid these objects and becomes visible for the operator. Thus, the augmented reality technique according to the invention will facilitate for an operator at which position on the workpiece the working of the workpiece should take place. Since the method according to the invention will facilitate the working of the workpiece for the operator the production rate and the accuracy when working of a workpiece will increase.

According to an aspect of the invention at least one passive marker element or a transponder is arranged on the template.

The at least one passive marker element or transponder, facilitates the orientation of the template and also the guide openings in relation to the at least one position element. The at least one passive marker element may be integrated with the template. The position of each guide opening in the template in relation to the at least one passive marker element is fixed. The distance between each guide opening and the at least one passive marker element may be determined by using traditional measurement tools. The transponder may be a semi passive marker element, which may be activated by energy from the positioning element.

The invention also relates to a computer program and a computer program product for performing the method steps according to the appended claims.

By the term “hole” is meant forming of an opening or recess in the material by the working process that results in a hole configuration or geometry. Thus, the hole is not limited to a circular hole but can be of any shape, such as triangular, polygonal shaped or a counter sink hole. The hole can be a through hole or a blind hole. Hence, by the term hole “diameter” is meant any distance straight across the opening that forms the hole and not only the largest opened distance cross the hole.

Further objects, advantages and novel features of the invention will become apparent to one skilled in the art from the following details, and also by put-ting the invention into practice. Whereas the invention is described below, it should be noted that it is not restricted to the specific details described. Specialists having access to the teachings herein will recognise further applications, modifications and incorporations within other fields, which are within the scope of the invention.

### BRIEF DESCRIPTION OF THE DRAWINGS

The invention will hereinafter be described with reference to embodiments of the invention and the enclosed figures, where

FIG. 1 shows a section view of a template connected to a workpiece according to the invention,

FIG. 2 shows a plane view of the template in FIG. 1,

FIG. 3a shows a side view of a drilling machine provided with a vibrator means,

FIG. 3b shows a side view of a measuring instrument,

FIG. 4 shows a side view of an orbital drilling apparatus,

FIG. 5 shows a view in perspective of a first embodiment of a system for working of a workpiece according to the invention,

FIG. 6 shows a view in perspective of a second embodiment of a system for working of a workpiece according to the invention,

FIG. 7 shows a view in perspective of a third embodiment of a system for working of a workpiece according to the invention,

FIG. 8 shows a view in perspective of a fourth embodiment of a system for working of a workpiece according to the invention, and

FIG. 9 illustrates a flow chart for a method for working of a workpiece according to the invention.

### DETAILED DESCRIPTION

The method and a system for working of a workpiece, and also the computer program and the computer program product for performing the method steps according to the invention will now be described by way of example only. The disclosure is not intended to limit the scope of the enclosed claims in any way.

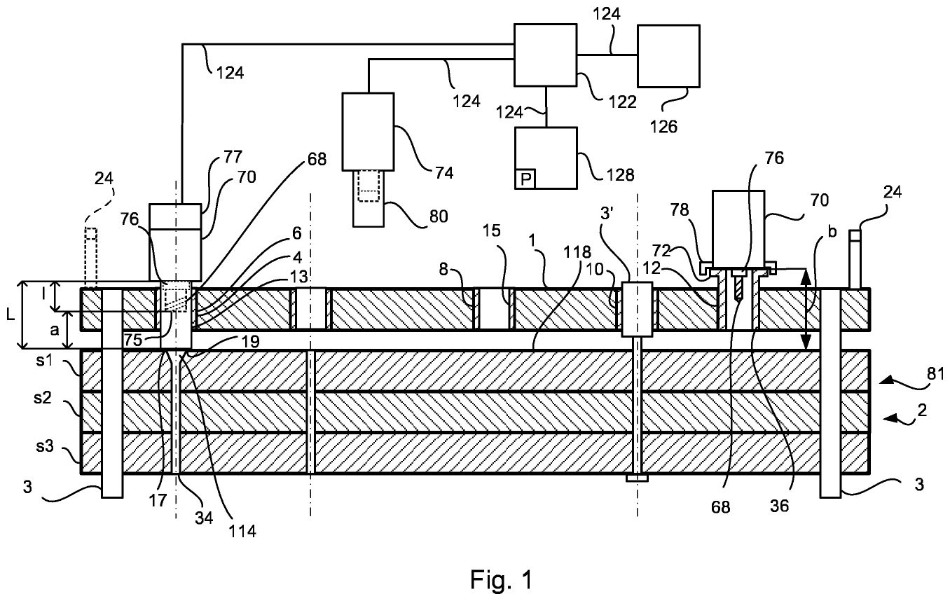

FIG. 1 shows a section view of a template 1 connected to an object, such as a workpiece 2 according to the invention. The template 1 is provided with a plurality of guide openings 4, 6, 8, . . . 12 located in a pattern corresponding to the positions of holes 34 to be formed in the workpiece 2 to which the template 1 is attached. The template 1 is connected to a workpiece 2, by means of connecting elements 3. As an alternative to the connecting elements 3, it is also possible to arrange temporary fasteners 3′ in undersized holes in the workpiece 2. The template 1 is connected to the temporary fasteners 3′ by using some the guide openings 4, 6, 8, . . . 12 in the template 1. After the holes 34 have been drilled and are finished in the workpiece 2, the temporary fasteners 3′ are moved to some of these finished holes 34 and the undersized holes are worked to correct size by means of a drilling machine 70. The guide openings 4, 6, 8, . . . 12 are adapted for the fixation of the work tool 70, 74 such as a drilling machine 70 or a measuring instrument 74 to the template 1. A collet 13 is arranged on the drilling machine 70 and enclosing at least partly the rotary cutting tool 68. The collet 13 is substantially cylindrical and concentric with the rotary cutting tool 68 and has a conical shape in order to be attached into the guide openings 4, 6, 8, . . . 12. A corresponding sleeve 15 may be arranged in each guide opening 4, 6, 8, . . . 12 to accommodate the collet 13. Alternatively, the collet 13 may be arranged to expand within the guide opening 4, 6, 8, . . . 12 and in the expanded state the drilling machine 70 is attached to the template 1. Guide bushings 36, 38, 40, . . . 64 may be inserted in the guide openings 4, 6, 8, . . . 12 of the template 1.

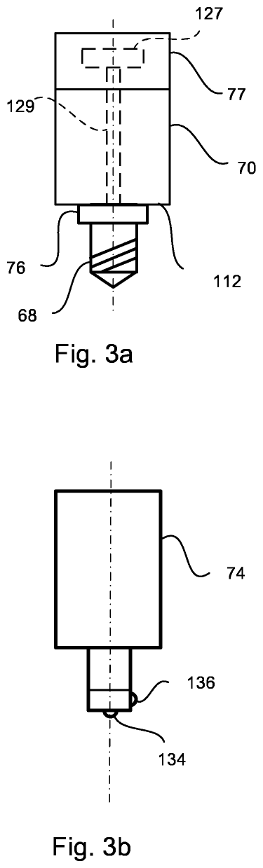

In order to know how deep the cutting tool 68 should be feeded into the workpiece 2 when making the hole 34 the distance a between a fixed reference 17 for the work tool 70, 74 and a surface 118 of the workpiece 2 facing the template 1 must be determined. The fixed reference 17 for the work tool 70, 74 is preferably situated on a first distal end 75 of the rotary cutting tool 68. The distance a is the difference between the length I of the rotary cutting tool 68 and the length L of the collet 13. When the drilling machine 70 is attached to the template 1 a second distal end 19 of the collet 13 is arranged to rest against the surface 118 of the workpiece 2. Also, the distance a may be measured by means of a hand held measuring instrument, such as a sliding caliper (not shown) or a measurement device as shown in FIG. 3b.

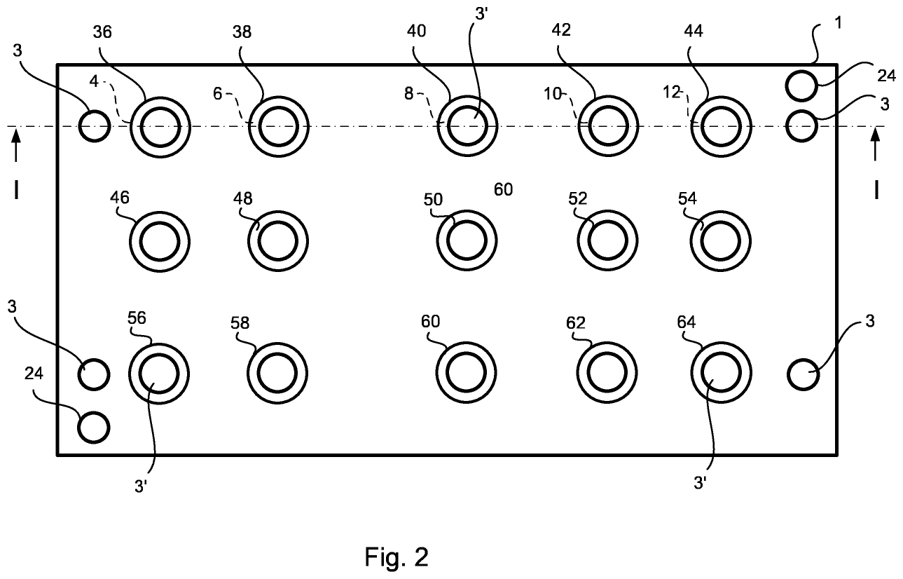

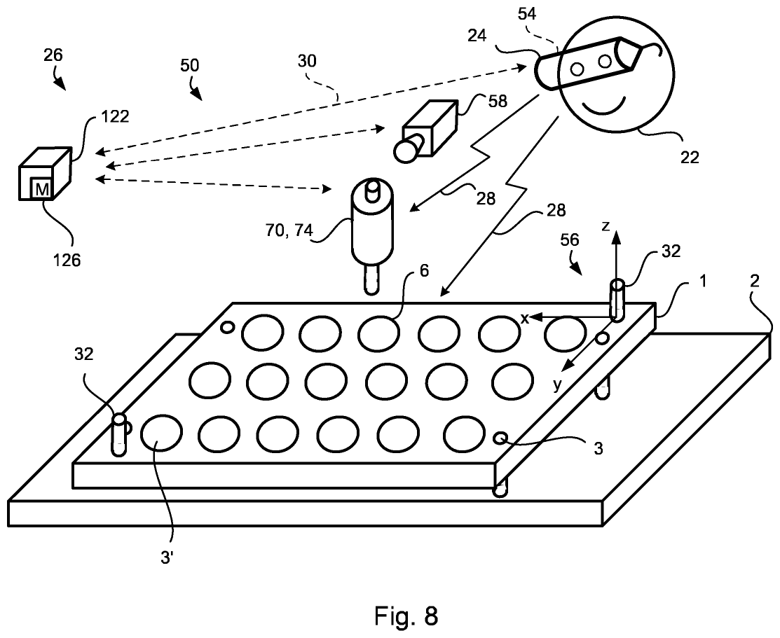

The drilling machine 70 has a drill chuck 76 for holding the rotary cutting tool 68, a vibration means 77 for vibrating the cutting tool 68 and a suitable fixation device 78 for fixating the machine 70 to the guide openings 4, 6, 8, . . . 12 in the template 1. Also, the measuring instrument 74 has a suitable fixation arrangement 80 for fixating the instrument 74 to the guide openings 4, 6, 8, . . . 12 in the template 1. The workpiece 2 may consist of a stack 81 of sheets s1, s2, s3 of different materials, such as fibre-reinforced composite materials, laminates, metals and stacks of identical or various materials, etc. In FIG. 2 the workpiece 2 consist of a stack 81 of three sheets s1, s2, s3, wherein each sheet s1, s2, s3 has a thickness and specific material characteristics. In order to produce holes 34 of various configurations and dimensions therein with help of one and the same cutting tool 68 use of a portable drilling machine 70 is preferred. As many holes 34 of various size and configurations are to be formed in a rapid sequence, an operator 22 (FIG. 8) may have difficulties in identifying the guide openings 4, 6, 8, . . . 12 in which the machine 70 is fixated, and establishing which specific hole-cutting processing data should be applied by the drilling machine 70 to the guide opening 4, 6, 8, . . . 12 in question.

Two position elements 24 are arranged on the template 1 for determining the position of the work tool 70, 74 and the position of the guide openings 4, 6, 8, . . . 12, so as to identify at which guide opening 4, 6, 8, . . . 12 the work tool 70, 74 is positioned. One, two or more than two position elements 24 may be arranged on the template 1. For example, if three position elements 24 are arranged on the template 1, triangulation may be used for determining the position of the work tool 70, 74 and the position of the guide openings 4, 6, 8, . . . 12. A system 26 for working of a workpiece 2 comprising the position elements 24 for determining the position of the work tool 70, 74 and the position of the guide openings 4, 6, 8, . . . 12 will be described below.

The vibrating means 77 is arranged to vibrate the cutting tool 68 in the longitudinal direction when making the hole 34. The cutting tool 68 also rotates when it vibrates. The vibrations create shorter flakes and contribute to lower the temperature of the cutting tool 68 and of the workpiece 2 during the hole making process. However, depending on the material in the workpiece 2 it is more or less suitable to vibrate the cutting tool 68. Therefore, when making holes 34 in a stack of sheets of different materials the vibrating means 77 can be switched on and off, or changed in parameters, depending on which sheet s1, s2, s3 in the stack 81 the cutting tool 68 is situated when making the hole 34.

When producing holes 34 in a stack 81 of sheets s1, s2, s3 of different materials information about the depth of the cutting tool 68 in the workpiece 2 is critical in order to know when the cutting tool 68 is situated in each of the sheet s1, s2, s3 during the cutting process. When knowing the thickness of each sheet s1, s2, s3 it can be decided how deep the cutting tool 68 should be feeded into the workpiece 2 with the vibrator means activated or deactivated when making the hole 34.

The frequency and amplitude of the vibrations, and also the rotating velocity and feeding rate of the cutting tool 68 depend on the material characteristics of the workpiece 2. The vibrating means 77 is preferably switched on when the cutting tool 68 reaches a sheet s1, s2, s3 in the stack 81, which consists of a material, such as titan or aluminum, wherein the flakes during the hole making process will be shorter and the cooling effect of both the cutting tool 68 and the workpiece 2 increases. However, before the cutting tool 68 leaves the sheet s1, s2, s3 and reaches the surface of the sheet s1, s2, s3 wherein the outgoing hole 34 of the sheet s1, s2, s3 will be situated the vibrating means 77 is preferably switched off. As a result a hole 34 with high accuracy and with a correct hole shape will be achieved and the surface of the sheet s1, s2, s3 will not be negative affected. When the cutting tool 68 reaches a sheet s1, s2, s3 in the stack 81, which consists of another type of material, such as fibre-reinforced composite materials the vibrating means 77 is preferably switched off because the vibrations may have an influence on the accuracy of the hole shape. Instead of switching off the vibrating means 77, the vibrating means 77 may be controlled so that the amplitude and/or the frequency of the vibrations may be changed.

The drilling machine 70, the vibrating means 77 and the measuring instrument 74 are connected to a control unit 122 by means of electrical wires 124. Also, a memory 126 is connected to the control unit 122 by means of electrical wires 124. The control unit 122 and the memory 126 may be installed into the drilling machine 70 or as separate units outside the drilling machine 70 and the measuring instrument 74. The drilling machine 70 and the measuring instrument 74 may also communicate wireless with the control unit 122 and the memory 126. The memory 126 may also be arranged within the control unit 122 and constitute a part of the control unit 122.

The drilling is controlled by a control unit 122. The control unit 122 receives information from the memory 126 about a receipt containing for example collected tool and material parameters, whereby the control unit 122 uses the information for running the drilling operation. The control unit 122 is preferably run by a computer 128, having a software algorithm adapted for providing calculations.

When providing the drilling machine 70 at one of the guide openings 4, 6, 8, . . . 12 in the template 1 the at least one position element 24 will determining the position of the drilling machine 70 and relate this position the adjacent guide opening 4, 6, 8, . . . 12. The system 26 will transmit this information to the memory 126 containing all relevant information of the respective hole 34 to be formed, such as type of hole 34, various processing and dimensional parameters thereof, e.g. diameter, depth and configuration of the hole 34, cutting advancement speed, shape of countersinks 114, etc. Also, information about number of sheets s1, s2, s3 in the stack 81, material characteristics of the material in each of the sheets s1, s2, s3 and the thickness of each sheet s1, s2, s3 are transmitted. Then, the control unit 122 is adapted to control the machine 70 to carry out the relevant hole cutting process in the workpiece 2 and switch on and off the vibrating means 77 depending on information transmitted to and from the control unit 122. Thus, the operator 22 may only have to fixate the drilling machine 72 on the bushing 36-64 and to activate it to initiate the relevant hole-cutting process.

After the production of all holes 34 in the workpiece 2 a control measurement thereof may be performed by means of the measuring instrument 74 to establish any discrepancies from the predetermined parameters requiring renewed treatment of the hole 34 in question or to match the hole 34 with a suitable fastening element having dimensions adapted to the hole 34. The drilling machine 70, the measuring instrument 74, the control unit 122, the computer 128 and the memory 126 may be connected to a local network 30.

Measurement results of the drilled holes 34 are stored in the memory 126. The data from the memory 126 may then be used for checking whether the holes 34 in the workpiece 2 have been drilled in a correct sequence, at the right time, with the correct parameters, by a correct cutting tool 68, etc.

As an alternative, in FIG. 1 is a guide bushing 36 inserted in the guide opening 12 of the template 1 to guide a rotary cutting tool 68. The guide bushing 36 is provided with a flange 72 for the fixation of the work tool such as a drilling machine 70 and also a measuring instrument 74 to the template 1.

The drilling machine 70 has a drill chuck 76 for holding the rotary cutting tool 68 and a suitable fixation device 78 for fixating the machine 70 to the guide bushing 36 of the template 1. Also, the measuring instrument 74 may have a suitable fixation arrangement (not shown) for fixating the instrument 74 to the guide bushing 36 of the template 1.

When producing holes 34 in a stack of materials requiring different process parameters, or provided with a countersink 114 the depth of the countersink 114 in the work piece 2 is critical in order to achieve an interacting connection between a fastener element (not disclosed) and the hole 34 provided with the countersink 114. Therefore, a distance b between a fixed point 116 on the identified guide bushing 36 and a surface 118 of the work piece 2 facing the template 1 must be determined in order to know how deep the cutting tool 68 should be feeded into the work piece 2 when making the hole 34. The measuring instrument 74 is provided on the identified guide bushing 36 for measuring the distance b between the fixed point 116 on the identified bushing 36 and the surface 118 of the work piece 2 facing the template 1. Preferably, the fixed point 116 on the identified bushing 36 coincide with a surface 120 on the bushing 36 which facing away from said surface 118 of the work piece 2. The measuring instrument 74 is adapted to be connected to the flange 72 of the bushing 36. When performing the measuring of the distance b, a first probe 134 (FIG. 3b) on the measuring instrument 74 is preferably directed towards the surface 118 of the workpiece 2.

FIG. 2 shows a plane view of a template 1 connected to a workpiece 2, by means of the connecting elements 3 according to the invention and as an alternative by the temporary fasteners 3′. FIG. 1 represents the section view along line I-I in FIG. 2. The guide openings 4, 6, 8, . . . 12 are located in a pattern in the template 1 corresponding to the positions of holes 34 to be formed in the workpiece 2 to which the template 1 is attached. Guide bushings 36, 38, 40, . . . 64 may be inserted in the guide openings 4, 6, 8, . . . 12 of the template 1 to form guide openings 4, 6, 8, . . . 12 for a rotary cutting tool 68. The bushings 36-64 may be provided with a flange (not shown) for the fixation of the work tool 70, 74 such as a drilling machine 70 and also a measuring instrument 74 to the template 1.

FIG. 3a shows a side view of the drilling machine 70 provided with a vibrating means 77 according to the second embodiment of the invention. The vibrating means 77 comprises a vibrating element 127 connected to the cutting tool 68 via a shaft 129 in the drilling machine 70. The vibrating means 77 may for example be made of a piezo electrical element or a mechanical rotating element which creates vibrations when it rotates. The drill chuck 76 for holding the rotary cutting tool 68 and the collet 13 for fixating the machine 70 to the bushings 36-64 of the template 1 are also shown in FIG. 3a.

FIG. 3b shows a side view of the measuring instrument 74 according to the second embodiment of the invention. The measuring instrument 74 comprises a first and a second probe 134, 136 which are directed in different directions. When performing the measuring of the distance B (FIG. 1), the first probe 134 is preferably directed towards the surface 118 of the workpiece 2. When performing the measuring of the shape of the worked hole 34 the second probe 136 is preferably directed in a radial direction to the worked hole 34 in the workpiece 2 or in an angel in relation to the radial direction to the worked hole 34 in the workpiece 2. However, it is also possible to provide two different measuring instruments 74, one instrument comprising a first probe 134 directed towards the surface 118 of the workpiece 2 and another instrument comprising a second probe 136 directed in a radial direction to the worked hole 34 in the workpiece 2.

Alternatively, the work tool is a cleansing tool (not shown) performing a cleansing process at the workpiece 2. Cleansing the workpiece 2 by means of a cleansing tool may facilitate the further working of the workpiece 2. When working of a cleaned workpiece 2 the accuracy of the finished product which emanates from the workpiece 2 may increase.

According to a further alternative, the work tool may be a mounting tool (not shown), performing a mounting process on the workpiece 2. Such mounting tool may be a screw driver, a riveting tool, a welding tool or the like for attaching components to the workpiece 2 or for attaching the workpiece 2 to a component.

The drilling machine 70 may be an orbital drilling apparatus which is characterized by a cutting tool diameter that is less than the diameter of the resulting hole 34; a tool cutting edge that is intermittently in contact with the hole edge; small chip formation; and a low thrust force.

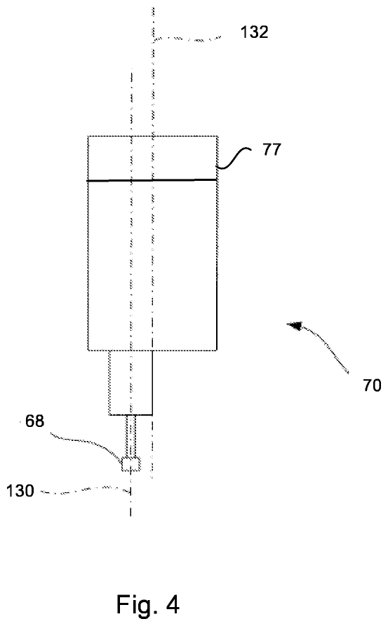

FIG. 4 shows a side view of the drilling machine 70 in form of an orbital drilling apparatus, comprising a cutting tool 68 for drilling a hole 34 in a workpiece 2. The cutting tool 68 has a cutting tool axis 130. The cutting tool 68 is rotated about its own axis 130 as well as eccentrically about a principal axis 132 of the orbital drilling apparatus. The orbital drilling apparatus could be provided with a vibrating means 77 according to the invention and is arranged to vibrate the cutting tool 68 along the axis 130.

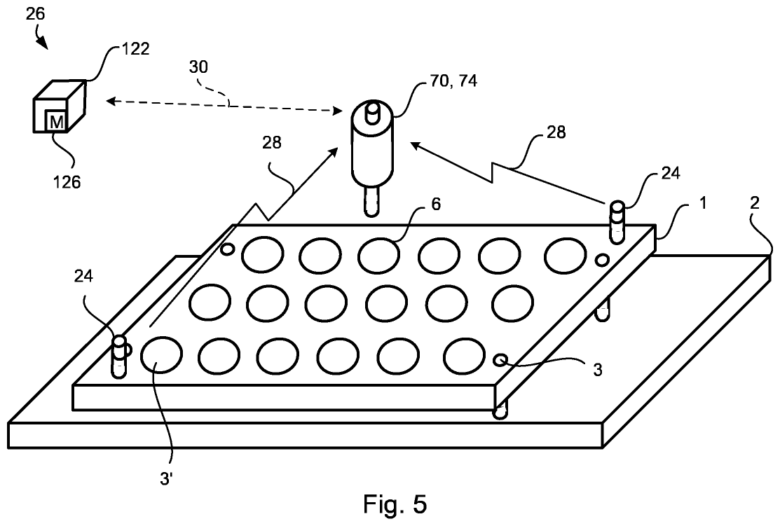

FIG. 5 shows a view in perspective of a first embodiment of a system 26 for working of the workpiece 2 according to the invention. According to this embodiment two position elements 24 are attached to the template 1. The position elements 24 may be integrated with the template 1, so that the position of each guide opening 4, 6, 8, . . . 12 in the template 1 in relation to the at least one position element 24 is fixed. The distance between each guide opening 4, 6, 8, . . . 12 and the at least one position element 24 may be determined by using traditional measurement tools (not shown).

The position elements 24 are based on laser, camera, ultra sound and/or radio triangulation techniques and signals are emitted from the position elements 24 in the direction of the working tool. The emitted signals are represented by arrows 28 in FIG. 5. The laser, camera, ultra sound and/or radio triangulation techniques may be combined for determining the position of the work tool 70, 74 or may be used individually. When the work tool 70, 74 is provided adjacent to or in one of the guide openings 4, 6, 8, . . . 12 the position elements 24 detect the position of the work tool 70, 74 by means of the laser, camera, ultra sound and/or radio triangulation technique. As a result, it will be possible to identify at which guide opening 4, 6, 8, . . . 12 the work tool 70, 74 has been positioned. Thus, the system 26 according to the invention may use a local positioning system LPS for identifying at which guide opening 4, 6, 8, . . . 12 the work tool 70, 74 has been positioned.

When providing the work tool 70, 74 at one of the guide openings 4, 6, 8, . . . 12 in the template 1 the position elements 24 will determine the position of the work tool 70, 74 and relate this position the adjacent guide opening 4, 6, 8, . . . 12. The system 26 may by the local network 30 transmit this information to the memory 126 in the control unit 122 containing all relevant information of the respective hole 34 to be formed, such as type of hole 34, various processing and dimensional parameters thereof, e.g. diameter, depth and configuration of the hole 34, cutting advancement speed, shape of countersinks 114, etc. Also, information about number of sheets s1, s2, s3 (FIG. 1) in the stack 81, material characteristics of the material in each of the sheets s1, s2, s3 and the thickness of each sheet s1, s2, s3 are transmitted. Then, the control unit 122 is adapted to control the work tool 70, 74 to carry out the relevant working of the workpiece 2 and possibly switching on and off, or changing the process parameters for, the vibrating means 77 depending on information transmitted to and from the control unit 122 and if holes 34 should be cut in the workpiece 2. Thus, the operator 22 may only have to provide the work tool 70, 74 to the guide opening 4, 6, 8, . . . 12, fixate the work tool 70, 74 in the guide opening 4, 6, 8, . . . 12 and to activate the work tool 70, 74 to initiate the relevant working process.

By determining the position of the work tool 70, 74 by means of the at least one position element 24 in relation to the guide openings 4, 6, 8, . . . 12 in the template 1, the method according to the invention will facilitate for an operator 22 at which position on the workpiece 2 the working of the workpiece 2 should take place. Since the method according to the invention will facilitate the working of the workpiece 2 for the operator 22 the production rate and the accuracy when working of a workpiece 2 will increase.

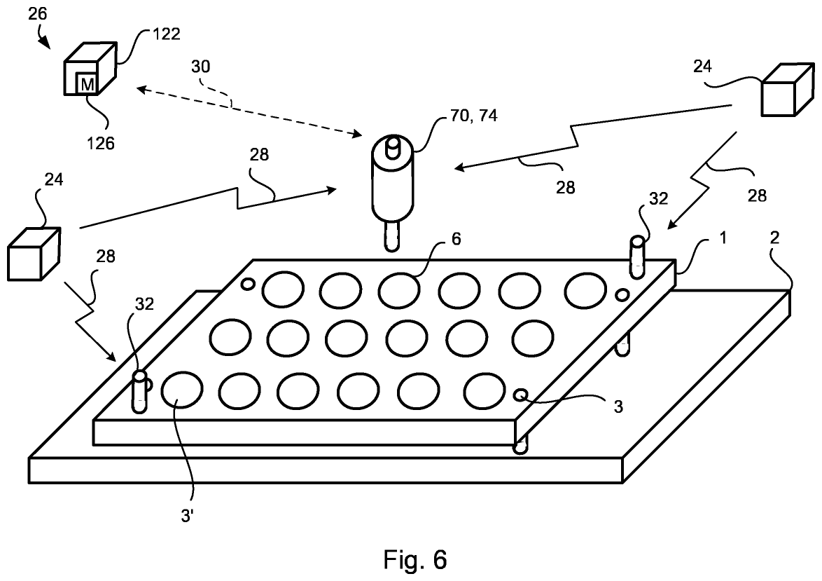

FIG. 6 shows a view in perspective of a second embodiment of a system 26 for working of a workpiece 2 according to the invention. According to this embodiment the position elements 24 are arranged at a distance to the template 1. Such a system 26 may be flexible and adaptable to large templates 1. The position elements 24 may be arranged at the workpiece 2, on a floor (not shown) or at walls (not shown) in the vicinity of the template 1. Two passive marker elements or transponders 32 are arranged on the template 1 which facilitates the orientation of the template 1 and also the guide openings 4, 6, 8, . . . 12 in relation to the position elements 24. The passive marker elements or transponders 32 may be integrated with the template 1. The position of each guide opening 4, 6, 8, . . . 12 in the template 1 in relation to passive marker elements or transponders 32 is fixed. The distance between each guide opening 4, 6, 8, . . . 12 and each of the passive marker elements 32 may be determined by using traditional measurement tools.

The position elements 24 are based on laser, camera, ultra sound and/or radio triangulation techniques and signals are emitted from the position elements 24 in the direction of the working tool and to the passive marker elements or transponders 32. The emitted signals are represented by arrows 28 in FIG. 6. The laser, camera, ultra sound and/or radio triangulation techniques may be combined or may be used individually. When the work tool 70, 74 is provided adjacent to or in one of the guide openings 4, 6, 8, . . . 12 the position elements 24 detect the position of the work tool 70, 74 by means of the laser, camera, ultra sound and/or radio triangulation technique. As a result, it will be possible to identify at which guide opening 4, 6, 8, . . . 12 the work tool 70, 74 has been positioned. Thus, the system 26 according to the invention may use a local positioning system LPS for identifying at which guide opening 4, 6, 8, . . . 12 the work tool 70, 74 has been positioned.

When providing the work tool 70, 74 at one of the guide openings 4, 6, 8, . . . 12 in the template 1 the position elements 24 will determine the position of the work tool 70, 74 and relate this position the adjacent guide opening 4, 6, 8, . . . 12. The system 26 may by the local network 30 transmit this information to the memory 126 in the control unit 122 containing all relevant information of the respective hole 34 to be formed, such as type of hole 34, various processing and dimensional parameters thereof, e.g. diameter, depth and configuration of the hole 34, cutting advancement speed, shape of countersinks 114, etc. Also, information about number of sheets s1, s2, s3 (FIG. 1) in the stack 81, material characteristics of the material in each of the sheets s1, s2, s3 and the thickness of each sheet s1, s2, s3 are transmitted. Then, the control unit 122 is adapted to control the work tool 70, 74 to carry out the relevant working of the workpiece 2 and switch on and off, or change the process parameters for, the vibrating means 77 depending on information transmitted to and from the control unit 122 and if holes 34 should be cut in the workpiece 2. Thus, the operator 22 may only have to provide the work tool 70, 74 to the guide opening 4, 6, 8, . . . 12, fixate the work tool 70, 74 in the guide opening 4, 6, 8, . . . 12 and to activate the work tool 70, 74 to initiate the relevant working process.

By determining the position of the work tool 70, 74 by means of the at least one position element 24 in relation to the guide openings 4, 6, 8, . . . 12 in the template 1, the method according to the invention will facilitate for the operator 22 at which position on the workpiece 2 the working of the workpiece 2 should take place. Since the method according to the invention will facilitate the working of the workpiece 2 for the operator 22 the production rate and the accuracy when working of a workpiece 2 will increase.

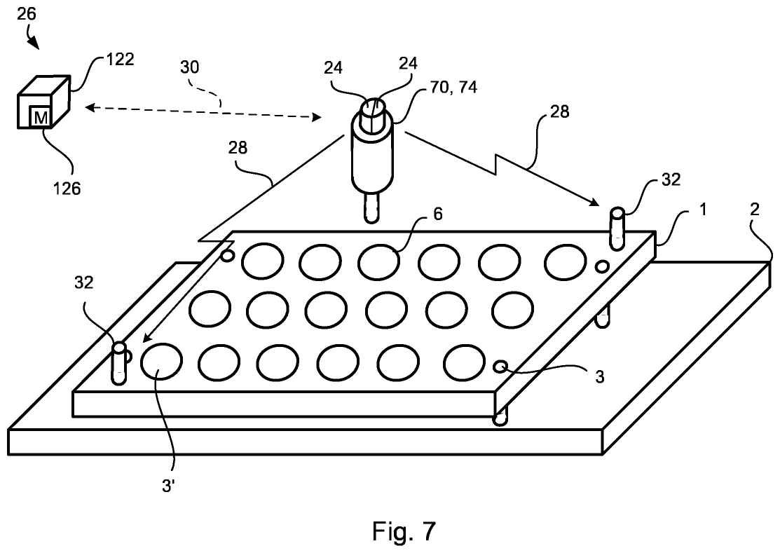

FIG. 7 shows a view in perspective of a third embodiment of a system 26 for working of a workpiece 2 according to the invention. According to this embodiment two positioning elements are arranged on the work tool 70, 74. When attaching the position elements 24 to the work tool 70, 74 a very compact and flexible system 26 is achieved. Two passive marker elements or transponders 32 are arranged on the template 1 which facilitates the orientation of the template 1 and also the guide openings 4, 6, 8, . . . 12 in relation to the position elements 24. The passive marker elements or transponders 32 may be integrated with the template 1. The position of each guide opening 4, 6, 8, . . . 12 in the template 1 in relation to passive marker elements 32 is fixed. The distance between each guide opening 4, 6, 8, . . . 12 and each of the passive marker elements 32 may be determined by using traditional measurement tools.

The position elements 24 are based on laser, camera, ultra sound and/or radio triangulation techniques and signals are emitted from the position elements 24 in the direction of the working tool and to the passive marker elements or transponders 32. The emitted signals are represented by arrows 28 in FIG. 7. The laser, camera, ultra sound and/or radio triangulation techniques may be combined or may be used individually. When the work tool 70, 74 is provided adjacent to or in one of the guide openings 4, 6, 8, . . . 12 the position elements 24 detect the position of the work tool 70, 74 by means of the laser, camera, ultra sound and/or radio triangulation technique. As a result, it will be possible to identify at which guide opening 4, 6, 8, . . . 12 the work tool 70, 74 has been positioned. Thus, the system 26 according to the invention may use a local positioning system LPS for identifying at which guide opening 4, 6, 8, . . . 12 the work tool 70, 74 has been positioned.

When providing the work tool 70, 74 at one of the guide openings 4, 6, 8, . . . 12 in the template 1 the position elements 24 will determine the position of the work tool 70, 74 and relate this position the adjacent guide opening 4, 6, 8, . . . 12. The system 26 may by the local network 30 transmit this information to the memory 126 in the control unit 122 containing all relevant information of the respective hole 34 to be formed, such as type of hole 34, various processing and dimensional parameters thereof, e.g. diameter, depth and configuration of the hole 34, cutting advancement speed, shape of countersinks 114, etc. Also, information about number of sheets s1, s2, s3 (FIG. 1) in the stack 81, material characteristics of the material in each of the sheets s1, s2, s3 and the thickness of each sheet s1, s2, s3 are transmitted. Then, the control unit 122 is adapted to control the work tool 70, 74 to carry out the relevant working of the workpiece 2 and switch on and off, or change the process parameters for, the vibrating means 77 depending on information transmitted to and from the control unit 122 and if holes 34 should be cut in the workpiece 2. Thus, the operator 22 may only have to provide the work tool 70, 74 to the guide opening 4, 6, 8, . . . 12, fixate the work tool 70, 74 in the guide opening 4, 6, 8, . . . 12 and to activate it to initiate the relevant working process.

By determining the position of the work tool 70, 74 by means of the at least one position element 24 in relation to the guide openings 4, 6, 8, . . . 12 in the template 1, the method according to the invention will facilitate for the operator 22 at which position on the workpiece 2 the working of the workpiece 2 should take place. Since the method according to the invention will facilitate the working of the workpiece 2 for the operator 22 the production rate and the accuracy when working of a workpiece 2 will increase.

FIG. 8 shows a view in perspective of a fourth embodiment of a system 26 for working of a workpiece 2 according to the invention. According to this embodiment the system 26 is based on augmented reality technique 50. The operator 22 wears eyeglasses 24 which comprise the position element 24. The eyeglasses 24 are connected to the control unit 122 and the operator 22 receives information about the position of the work tool 70, 74 and can relate this position the adjacent guide opening 4, 6, 8, . . . 12. On a display 54 in the eyeglasses 24 also information can be presented about which guide opening 4, 6, 8, . . . 12 in the template 1 should be used. For example may this guide opening 4, 6, 8, . . . 12 be highlighted in the eyeglasses 24, so that the operator 22 can fixate the work tool 70, 74 in this guide opening 4, 6, 8, . . . 12.

When the working of the workpiece 2 is augmented or supplemented by computer-generated sensory input the position of the work tool 70, 74 and the position where working should take place on the workpiece 2 by said work tool 70, 74 will effectively determined. By adding computer vision and object recognition the information about the template 1, work piece and work tool 70, 74 in front of the operator 22 becomes interactive and digitally manipulable. The information about the template 1, work piece, work tool 70, 74 and other equipment in the environment surrounding the operator 22 is overlaid these objects and becomes visible for the operator 22. Thus, the augmented reality technique 50 according to the invention will facilitate for an operator 22 at which position on the workpiece 2 the working of the workpiece 2 should take place. Since the method according to the invention will facilitate the working of the workpiece 2 for the operator 22 the production rate and the accuracy when working of a workpiece 2 will increase.

Two passive marker elements or transponders 32 are arranged on the template 1 which facilitates the orientation of the template 1 and also the guide openings 4, 6, 8, . . . 12 in relation to the position elements 24. The passive marker elements or transponders 32 may be integrated with the template 1. The position of each guide opening 4, 6, 8, . . . 12 in the template 1 in relation to passive marker elements or transponders 32 is fixed. The distance between each guide opening 4, 6, 8, . . . 12 and each of the passive marker elements 32 may be determined by using traditional measurement tools (not shown). The passive marker elements or transponders 32 are included in a coordinate system 56, so that the position in space of the passive marker elements or transponders 32 is determined.

A camera 58 is directed at the template 1, so that real time images of the template 1, work tool 70, 74 and the workpiece 2 are captured and delivered to the control unit 122.

The augmented reality technique 50 according to this embodiment may be combined with a system 26 according to any of the systems 22 according to the previous embodiments or another local positioning system LPS for identifying at which guide opening 4, 6, 8, . . . 12 the work tool 70, 74 has been positioned.

When providing the work tool 70, 74 at one of the guide openings 4, 6, 8, . . . 12 in the template 1 the position element 24 in form of the eyeglasses 24 will determine the position of the work tool 70, 74 and relate this position the adjacent guide opening 4, 6, 8, . . . 12. This information may by the local network 30 be transmitted to the memory 126 in the control unit 122 containing all relevant information of the respective hole 34 to be formed, such as type of hole 34, various processing and dimensional parameters thereof, e.g. diameter, depth and configuration of the hole 34, cutting advancement speed, shape of countersinks 114, etc. Also, information about number of sheets s1, s2, s3 (FIG. 1) in the stack 81, material characteristics of the material in each of the sheets s1, s2, s3 and the thickness of each sheet s1, s2, s3 are transmitted. Then, the control unit 122 is adapted to control the work tool 70, 74 to carry out the relevant working of the workpiece 2 and switch on and off, or change the process parameters for, the vibrating means 77 depending on information transmitted to and from the control unit 122 and if holes 34 should be cut in the workpiece 2. Thus, the operator 22 may only have to provide the work tool 70, 74 to the guide opening 4, 6, 8, . . . 12, fixate the work tool 70, 74 in the guide opening 4, 6, 8, . . . 12 and to activate it to initiate the relevant working process. Instead of eyeglasses 24 the operator 22 may use another eyewear, such as a helmet with a built in screen (not shown).

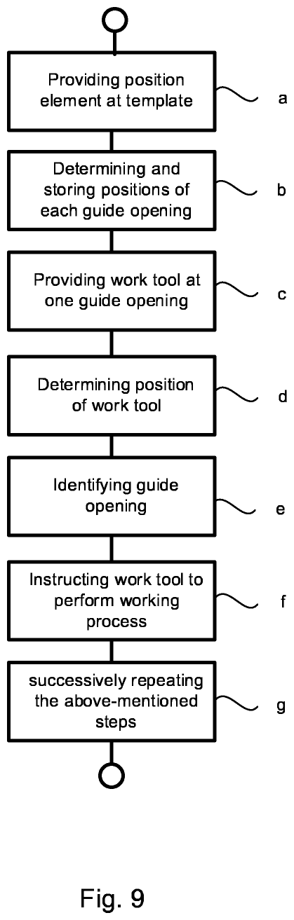

In operation, the method according to the invention is illustrated in a block diagram in FIG. 9. The method according to the invention comprising the step of:

a) providing at least one position element 24 at the template 1;
b) determining the position of each guide opening 4, 6, 8, . . . 12 in the template 1 in relation to the at least one position element 24 and storing the positions in a hole database 48 in a memory 126 containing relevant process and dimensional parameters of each hole 34 to be formed in the workpiece 2;
c) providing the work tool 70, 74 at one guide opening 4, 6, 8, . . . 12;
d) determining the position of the work tool 70, 74 by means of the at least one position element 24;
e) identifying at which guide opening 4, 6, 8, . . . 12 the work tool 70, 74 has been positioned by collecting information from the hole database 48;
f) instructing, by means of a control unit 50 communicating with the hole database 48, the work tool 70, 74 to perform a working process relevant to the identified position of the work tool 70, 74; and
g) successively repeating the above-mentioned steps a)-f) to complete the working process for all holes 34 in the workpiece 2.

According to one embodiment the at least one position element 24 in step d) determining the position of the work tool 70, 74 by means of laser, camera, ultra sound and/or radio triangulation technique.

According to one embodiment, the at least one position element 24 in step d), determining the position of the work tool 70, 74 by means of augmented reality technique 50.

According to one embodiment, in which the work tool 70, 74 is a drilling machine comprising a rotary cutting tool 68, the working process in step f) comprises a hole-cutting process performed in the workpiece 2.

According to one embodiment, during the hole-cutting process in step f), the rotary cutting tool 68 is vibrated in the longitudinal direction by means of a vibrating means 77 or orbited in a helical motion when feeded into the workpiece 2.

According to one embodiment, in which the work tool 70, 74 is a measuring tool, the working process in step f) comprises a measuring process performed on the workpiece 2.

The system 26 for measuring and working objects comprises a computer 128 including a computer program P for carrying out the method according to the invention, in which a software algorithm provides said calculations about the measuring operation.

The invention also relates to a computer program P and a computer program product for performing the method steps. The computer program P comprises a program code for performing the method steps according to the invention as mentioned herein, when said computer program P is run on a computer 128. The computer program product comprises a program code stored on a, by a computer 128 readable, media for performing the method steps according to the invention as mentioned herein, when said computer program P is run on the computer 128. Alternatively, the computer program product is directly storable in an internal memory 126 into the computer 128, comprising a computer program P for performing the method steps according to the invention, when said computer program P is run on the computer 128.

The foregoing description of the preferred embodiments of the invention is provided for illustrative and descriptive purposes. It is not intended to be exhaustive or to restrict the invention to the variants described. Many modifications and variations will obviously be apparent to one skilled in the art. The embodiments have been chosen and described in order best to explain the principles of the invention and its practical applications and hence make it possible for specialists to understand the invention for various embodiments and with the various modifications appropriate to the intended use. Features and components of the different embodiments above may be combined within the scope of the invention.

1. A method of working of a workpiece using a work tool, said workpiece having attached thereto a template with preformed guide openings located in a pattern corresponding to the positions of the holes to be formed in the workpiece,
wherein the method comprises the steps of:
a) providing at least one position element at the template;
b) determining a position of each guide opening in the template in relation to the at least one position element and storing the positions in a hole database in a memory containing relevant process and dimensional parameters of each hole to be formed in the workpiece;
c) providing the work tool at one guide opening;
d) determining the position of the work tool by the at least one position element;
e) identifying at which guide opening the work tool has been positioned by collecting information from the hole database;
f) instructing, by a control unit communicating with the hole database, the work tool to perform a working process relevant to an identified position of the work tool; and
g) successively repeating the above-mentioned steps a)-f) to complete the working process for all holes in the workpiece.

2. The method according to claim 1, wherein the at least one position element in step d) determining the position of the work tool is done by at least one of a laser, camera, ultra sound and/or radio triangulation technique.

3. The method according to claim 1, wherein the at least one position element in step d) determining the position of the work tool is done by an augmented reality technique.

4. The method according to claim 1, wherein the work tool is a drilling machine comprising a rotary cutting tool, whereby the working process in step f) comprises a hole-cutting process performed in the workpiece.

5. The method according to claim 4, wherein during the hole-cutting process in step f), the rotary cutting tool is vibrated in the longitudinal direction by a vibrator or orbited in a helical motion when fed into the workpiece.

6. The method according to claim 1, wherein the work tool is a measuring tool,
whereby the working process in step f) comprises a measuring process performed on the workpiece.

7. A system for working of a workpiece, comprising a work tool, a template attached to said workpiece, which template is provided with guide openings located in a pattern corresponding to the positions of holes to be formed in the workpiece,
wherein an at least one position element is provided at the template, which the at least one position element is arranged to determine the position of the work tool and the position of the guide openings, to identify at which guide opening the work tool is positioned.

8. The system according to claim 7, wherein the at least one position element is attached to the template.

9. The system according to claim 7, wherein the at least one position element is arranged at a distance to the template.

10. The system according to claim 7, wherein the at least one position element is attached to the work tool.

11. The system according to claim 7, wherein the at least one position element is based on at least one of a laser, camera, ultra sound or radio triangulation technique.

12. The system according to claim 7, wherein the at least one position element is based on an augmented reality technique.

13. The system according to claim 7, wherein the at least one passive marker element or transponder is arranged on the template.

14. A computer program comprising program code that, when said program code is executed in a computer, causes said computer to carry out the method according to claim 1.

15. A computer program product comprising a computer-readable medium and a computer program according to claim 14, wherein said computer program is contained in said computer-readable medium.
